(19) United States
(12) Patent Application Publication
(10) Pub. No.: US 2025/0296392 A1
(43) Pub. Date: Sep. 25, 2025

(54) PNEUMATIC TIRE

(71) Applicant: The Yokohama Rubber Co., LTD., Kanagawa (JP)

(72) Inventor: Shingo Ohira, Kanagawa (JP)

(21) Appl. No.: 19/080,400

(22) Filed: Mar. 14, 2025

(30) Foreign Application Priority Data
Mar. 19, 2024 (JP) 2024-043414

(51) Int. Cl. B60C 19/00; B60C 15/06

(52) U.S. Cl. CPC B60C 19/00; B60C 15/0607; B60C 15/0635; B60C 2015/0692; B60C 2019/004

(57) ABSTRACT

A pneumatic tire includes a tread portion extending in a circumferential direction and having an annular shape, a pair of sidewall portions respectively disposed on both sides of the tread portion, and a pair of bead portions respectively disposed on inner sides of the sidewall portions in a radial direction. A bead filler is disposed on an outer periphery of a bead core of each bead portion, a carcass layer is mounted between the pair of bead portions, and the carcass layer is turned up around the bead core from a tire inner side to a tire outer side. A transponder is embedded between the bead filler and the carcass layer, and a distance from an outer surface of the transponder to an outer surface of the bead filler measured in a normal line direction of the carcass layer ranges from 2 mm to 20 mm.

### CROSS-REFERENCE TO RELATED APPLICATIONS

This application claims priority pursuant to 35 U.S.C. 119 (a) to Japanese Patent Application No. 2024-043414, filed Mar. 19, 2024, which application is incorporated herein by reference in its entirety.

### TECHNICAL FIELD

The present technology relates to a pneumatic tire embedded with a transponder and relates particularly to a pneumatic tire that can provide improved cracking resistance of the tire and improved communication performance of the transponder.

### BACKGROUND

For pneumatic tires, embedding an RFID (Radio Frequency Identification) tag (transponder) in a tire has been proposed (see, for example, Japan Unexamined Patent Publication No. H07-137510 A). When a transponder is embedded inside a green tire and the green tire is then vulcanized, depending on the position at which the transponder is embedded, an improper rubber flow may occur during vulcanization, which may easily cause cracks on the surface of the vulcanized tire. The occurrence of such cracks is marked when the transponder is embedded in a portion where the rubber gauge of the tire is excessively thin. On the other hand, if the transponder is embedded in a portion where the rubber gauge of the tire is excessively thick, there is a problem that the communication performance of the transponder deteriorates.

### SUMMARY

The present technology provides a pneumatic tire that can provide improved cracking resistance of the tire and improved communication performance of a transponder.

A pneumatic tire according to an embodiment of the present technology includes a tread portion extending in a tire circumferential direction and having an annular shape, a pair of sidewall portions respectively disposed on both sides of the tread portion, and a pair of bead portions respectively disposed on inner sides of the sidewall portions in a tire radial direction, a bead filler being disposed on an outer periphery of a bead core of each bead portion, a carcass layer being mounted between the pair of bead portions, and the carcass layer being turned up around the bead core from a tire inner side to a tire outer side, a transponder being embedded between the bead filler and the carcass layer, and a distance W from an outer surface of the transponder to an outer surface of the bead filler measured in a normal line direction of the carcass layer ranging from 2 mm to 20 mm.

In the present technology, the transponder is embedded between the bead filler and the carcass layer. The typical thickness of a transponder is about 1 mm to 2 mm. However, when the transponder is embedded between the bead filler and the carcass layer, if the transponder is disposed at a position where the above rubber gauge cannot be ensured, an improper rubber flow occurs due to the thicknesses of the transponder during tire vulcanization. In contrast, in the present technology, the distance W from the outer surface of the transponder to the outer surface of the bead filler is set to range from 2 mm to 20 mm. Therefore, the transponder can be disposed so that a rubber gauge does not become excessively thick while ensuring the rubber gauge to such an extent that an improper rubber flow does not occur during vulcanization. This improves the cracking resistance of the tire while improving the communication performance of the transponder.

In the pneumatic tire of the present technology, a maximum thickness t of the transponder and the distance W preferably satisfy a relationship of 1≤W/t≤10. Accordingly, improper rubber flow can be suppressed during tire vulcanization, and cracking resistance can be effectively improved.

The bead filler preferably includes a first bead filler disposed adjacent to a tire-radial-direction outer side of the bead core and a second bead filler disposed adjacent to a tire-radial-direction outer side of the first bead filler, and the transponder is preferably disposed between the second bead filler and the carcass layer. Accordingly, the transponder is closer to the outer surface of the sidewall portion than in a case where the transponder is disposed on the first bead filler, and thus it is possible to effectively improve the communication performance of the transponder.

A hardness of the second bead filler is preferably lower than a hardness of the first bead filler and preferably ranges from 55 to 65. Since the second bead filler in which the transponder is embedded is made of a relatively soft rubber, the second bead filler absorbs the impact and the impact is hardly transmitted to the transponder. Accordingly, damage to the transponder can be prevented.

A carcass cord constituting the carcass layer is preferably a metal cord. Accordingly, the bending rigidity of the carcass cord is increased. Therefore, the carcass cord is less likely to be bent when the green tire comes into contact with a mold during vulcanization. Therefore, the cracking resistance can be effectively improved.

A metal reinforcing layer is preferably disposed on an outer side of the carcass layer in the bead portion. By disposing such a metal reinforcing layer, the bending rigidity is increased, and thus the green tire is less likely to be bent when coming into contact with a mold during vulcanization, which can effectively improve the cracking resistance.

The metal reinforcing layer is preferably turned up around the bead core from a tire inner side to a tire outer side, and the transponder is preferably disposed on a tire-radial-direction outer side of a turned-up end portion of the metal reinforcing layer. Accordingly, the transponder is disposed away from the metal member, and the communication performance of the transponder can be effectively improved. Further, since an unevenness formed at the turned-up end portion of the carcass layer and an unevenness formed at the transponder are disposed so as not to overlap with each other, the amount of unevenness is reduced, and it is possible to suppress the occurrence of cracks on the tire surface due to improper rubber flow.

The transponder is preferably disposed on a tire-radial-direction outer side of the turned-up end portion of the carcass layer. For example, when the tire is used as a heavy-duty tire, the carcass cord is formed of a metal cord. Therefore, the transponder is disposed away from the metal member, so that the communication performance of the transponder can be improved. Further, since an unevenness formed at the turned-up end portion of the carcass layer and an unevenness formed at the transponder are disposed so as not to overlap with each other, the amount of unevenness is reduced, and it is possible to suppress the occurrence of cracks on the tire surface due to improper rubber flow.

Preferably, the transponder is entirely covered with a coating layer made of rubber, and an absolute value |w1-w2| of a difference between a width w1 on a side of the coating layer in contact with the carcass layer and a width w2 on a side of the coating layer in contact with the bead filler is preferably 0.2 mm or more. Accordingly, the amount of unevenness around the transponder can be reduced, and the cracking resistance can be effectively improved. Furthermore, this enables the shape of the coating layer to be stabilized, thus effectively improving the communication performance of the transponder.

### BRIEF DESCRIPTION OF DRAWINGS

FIG. 1 is a meridian cross-sectional view illustrating one example of a pneumatic tire according to an embodiment of the present technology;

FIG. 2 is a cross-sectional view illustrating a main part of the pneumatic tire in FIG. 1;

FIG. 3 is a cross-sectional view illustrating a main part of a modified example of a pneumatic tire according to an embodiment of the present technology;

FIG. 4 is a cross-sectional view illustrating a main part of another modified example of a pneumatic tire according to an embodiment of the present technology;

FIG. 5 is a cross-sectional view illustrating a main part of another modified example of a pneumatic tire according to an embodiment of the present technology; and,

FIGS. 6A and 6B are enlarged views illustrating a transponder embedded in the pneumatic tire in FIG. 5; FIG. 6A being a perspective view and FIG. 6B being a cross-sectional view.

### DETAILED DESCRIPTION

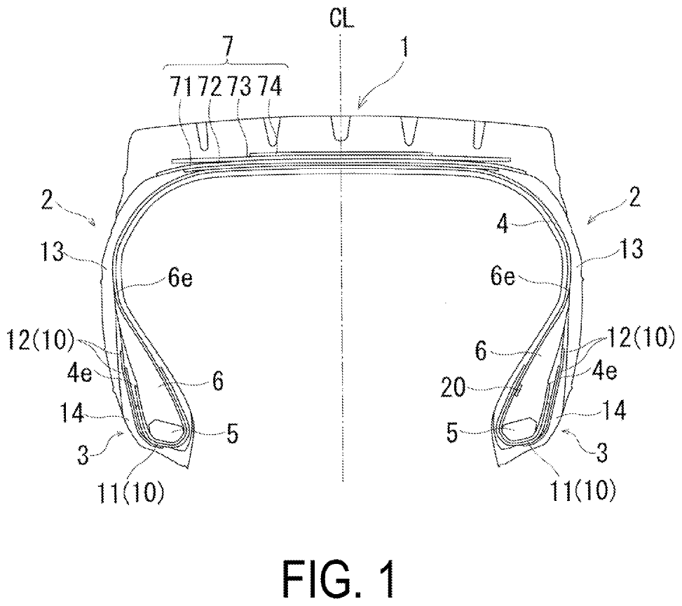

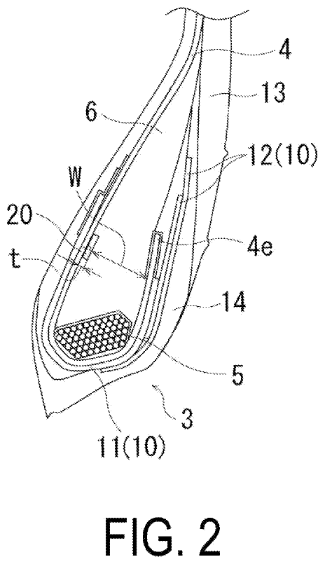

Configurations of embodiments of the present technology will be described in detail below with reference to the accompanying drawings. FIGS. 1 and 2 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on respective both sides of the tread portion 1, and a pair of bead portions 3 respectively disposed on inner sides of the pair of sidewall portions 2 in a tire radial direction.

At least one carcass layer 4 (one layer in FIG. 1) formed by arranging a plurality of carcass cords in the radial direction is mounted between the pair of bead portions 3. Metal cords such as steel cords are preferable as the carcass cord constituting the carcass layer 4. As a result, the bending rigidity of the carcass cord is increased. Therefore, the carcass cord is less likely to be bent when the green tire comes into contact with a mold during vulcanization, thereby contributing to an improvement in cracking resistance. Bead cores 5 having an annular shape are embedded within the bead portions 3, and bead fillers 6 made of a rubber composition and having a triangular cross-section are disposed on the outer peripheries of the bead cores 5.

A plurality of belt layers 7 (four layers in FIG. 1) are embedded on a tire-radial-direction outer side of the carcass layer 4 of the tread portion 1. Each of the belt layers 7 includes a plurality of belt cords (for example, steel cords) inclined with respect to the tire circumferential direction. The belt layers 7 include two central main belt layers 72, 73 with belt cords intersecting with each other, and auxiliary belt layers 71, 74 disposed on an inner side and an outer side of the main belt layers 72, 73 in the tire radial direction. The inclination angle of the belt cords constituting the main belt layers 72, 73 with respect to the tire circumferential direction is set to range, for example, from 15° to 35°, and the inclination angle of the belt cords constituting the auxiliary belt layers 71, 74 with respect to the tire circumferential direction is set to range, for example, from 15° to 75°.

In the pneumatic tire described above, a turned-up end portion 4e of the carcass layer 4 is disposed further on the inner side in the tire radial direction than a tire-radial-direction outer-side end portion 6e of the bead filler 6. That is, the turned-up end portion 4e of the carcass layer 4 terminates at the middle portion of the bead filler 6. A reinforcing layer 10 is disposed in each of the bead portions 3 in such a way as to wrap around the carcass layer 4, the bead core 5, and the bead filler 6. The reinforcing layer 10 includes at least one layer (one layer in FIG. 1) of a metal reinforcing layer 11 including a plurality of metal cords (for example, steel cords) and at least one layer (two layers in FIG. 1) of a non-metal reinforcing layer 12 disposed on the outer side of the metal reinforcing layer 11 in the tire width direction and including a plurality of organic fiber cords. By disposing such a metal reinforcing layer, the bending rigidity is increased, and thus the green tire is less likely to be bent when coming into contact with a mold during vulcanization, which contributes to an improvement in cracking resistance. Additionally, a sidewall rubber layer 13 exposed on the tire outer surface is disposed in a region extending from the sidewall portion 2 5 to the bead portion 3.

A rim cushion rubber layer 14 is disposed between the bead filler 6 and the sidewall rubber layer 13. The rim cushion rubber layer 14 extends from a lateral position of the bead filler 6 toward the inner side in the tire radial direction. That is, the rim cushion rubber layer 14 is disposed in a region ranging from a position on the inner side in the tire radial direction with respect to the tire-radial-direction outer-side end portion 6e of the bead filler 6 in the tire radial direction, to a position on the inner side of the bead core 5 in the tire radial direction. The rim cushion rubber layer 14 is disposed so as to cover the turned-up end portion 4e of the carcass layer 4, a turned-up end portion of the metal reinforcing layer 11, and the non-metal reinforcing layer 12.

In the pneumatic tire described above, a transponder 20 is embedded between the bead filler 6 and the carcass layer 4. In FIG. 2, the transponder 20 is embedded in an interface between a side surface (inner surface) of the bead filler 6 on the inner side in the tire width direction and the carcass layer 4. Additionally, the transponder 20 extends in the tire circumferential direction.

A distance W (see FIG. 2) from a side surface (outer surface) of the transponder 20 on the outer side in the tire width direction to a side surface (outer surface) of the bead filler 6 on the outer side in the tire width direction is set to range from 2 mm to 20 mm. The distance W is preferably in a range from 5 mm to 10 mm. The distance W is measured in a normal line direction of the carcass layer 4 with which the transponder 20 abuts.

As the transponder 20, for example, a radio frequency identification (RFID) tag can be used. The transponder 20 includes an IC (integrated circuit) substrate for storing data and an antenna for transmitting and receiving data in a non-contact manner. Using the transponder 20 such as that described above allows information related to the tire to be written or read on a timely basis and the tire to be efficiently managed. Here, “RFID” refers to an automatic recognition technology including: a reader/writer including an antenna and a controller; and an ID tag including an IC substrate and an antenna, the automatic recognition technology allowing data to be communicated in a wireless manner.

Further, the entirety of the transponder 20 is preferably covered with the coating layer made of rubber. For example, the coating layer coats the entirety of the transponder 20 while sandwiching both top and back surfaces of the transponder 20 between two rubber sheets. The transponder 20 is protected by the coating layer as described above, and thus the adhesiveness and the durability of the transponder 20 can be improved.

In the above-described pneumatic tire, the transponder 20 is embedded between the bead filler 6 and the carcass layer 4, and the distance W from the outer surface of the transponder 20 to the outer surface of the bead filler 6 is set in the range of from 2 mm to 20 mm. Therefore, the transponder 20 can be disposed so that a rubber gauge does not become excessively thick while ensuring the rubber gauge to such an extent that an improper rubber flow does not occur during vulcanization. This can improve the cracking resistance of the tire while improving the communication performance of the transponder 20. In the pneumatic tire described above, a maximum thickness t (see FIG. 2) of the transponder 20 and the distance W preferably satisfy a relationship of 1≤ W/t≤10, and more preferably satisfy a relationship of 2≤W/t≤6. Appropriately setting the ratio W/t in this manner can suppress improper rubber flow during tire vulcanization, and effectively improve cracking resistance. When the transponder is covered with the coating layer, the maximum thickness t of the transponder is a thickness including the thickness of the coating layer.

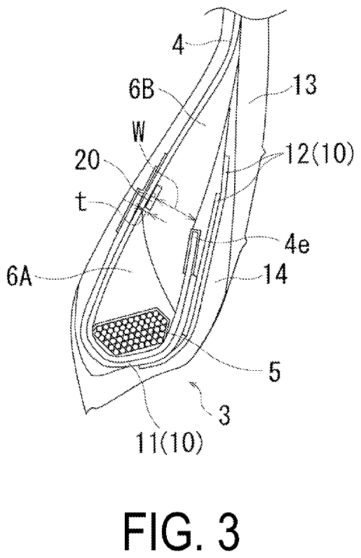

FIG. 3 illustrates a modified example of a pneumatic tire according to an embodiment of the present technology. As illustrated in FIG. 3, the bead filler 6 includes a first bead filler 6A disposed adjacent to the tire-radial-direction outer side of the bead core 5 and a second bead filler 6B disposed adjacent to the tire-radial-direction outer side of the first bead filler 6A. The first bead filler 6A and the second bead filler 6B are preferably made of rubbers having different physical properties from each other.

With respect to the bead filler 6 such as that described above, the transponder 20 is preferably disposed between the second bead filler 6B and the carcass layer 4. Since the transponder 20 is disposed between the second bead filler 6B and the carcass layer 4, the transponder 20 is closer to the outer surface of the sidewall portion 2 than in a case where the transponder 20 is disposed on the first bead filler 6A, and thus it is possible to effectively improve the communication performance of the transponder 20.

In particular, when the transponder 20 is arranged between the second bead filler 6B and the carcass layer 4, the hardness of the second bead filler 6B is preferably lower than the hardness of the first bead filler 6A. Further, the hardness of the second bead filler 6B preferably ranges from 55 to 65. Since the second bead filler 6B in which the transponder 20 is embedded is made of a relatively soft rubber as described above, the second bead filler 6B absorbs impact and the impact is hardly transmitted to the transponder 20. Accordingly, damage to the transponder 20 can be prevented. In an embodiment of the present technology, the hardness of the bead filler 6 is a durometer hardness specified in JIS (Japanese Industrial Standard) K6253, and is a hardness measured with a type A durometer at a temperature of 20° C. (JIS hardness).

Further, the transponder 20 is preferably disposed on the tire-radial-direction outer side of the turned-up end portion 4e of the carcass layer 4. Additionally, the transponder 20 is disposed 10 mm or more away from the turned-up end portion 4e of the carcass layer 4 on the tire-radial-direction outer side. By disposing the transponder 20 away from the turned-up end portion 4e of the carcass layer 4 as described above, the communication performance of the transponder 20 can be sufficiently ensured. Further, since an unevenness formed at the turned-up end portion 4e of the carcass layer 4 and an unevenness formed at the transponder 20 are disposed so as not to overlap with each other, the amount of unevenness is reduced, and it is possible to suppress the occurrence of cracks on the tire surface due to improper rubber flow. On the other hand, in the case of a heavy-duty tire, the carcass cords are generally constituted by metal cords. Therefore, if such a metal member is disposed farther toward the tire-radial-direction outer side than the transponder, the communication performance of the transponder tends to deteriorate.

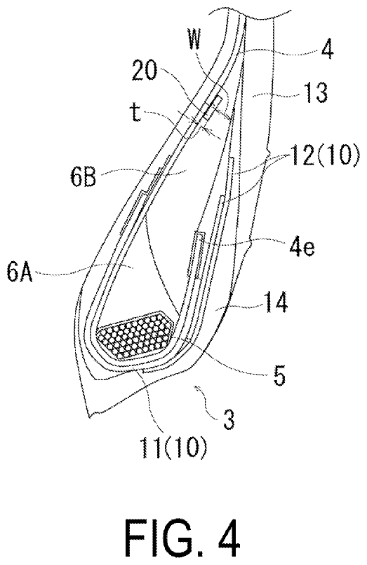

FIG. 4 illustrates another modified example of a pneumatic tire according to an embodiment of the present technology. FIG. 3 illustrates an example in which the transponder 20 is embedded in a substantially central portion of the bead filler 6 in the tire radial direction. However, FIG. 4 illustrates an example in which the transponder 20 is embedded in a relatively high position of the bead filler 6 in the tire radial direction.

As illustrated in FIG. 4, the bead filler 6 includes the first bead filler 6A and the second bead filler 6B. For such a bead filler 6, the transponder 20 is preferably disposed on the tire-radial-direction outer side with respect to an end portion (upper end) of the metal reinforcing layer 11 on the tire-radial-direction outer side. By disposing the transponder 20 as described above, the transponder 20 is disposed away from the metal member, and the communication performance of the transponder 20 can be effectively improved. Further, since the unevenness formed at the turned-up end portion 4e of the carcass layer 4 and the unevenness formed at the transponder 20 are disposed so as not to overlap with each other, the amount of unevenness is reduced, and it is possible to suppress the occurrence of cracks on the tire surface due to improper rubber flow.

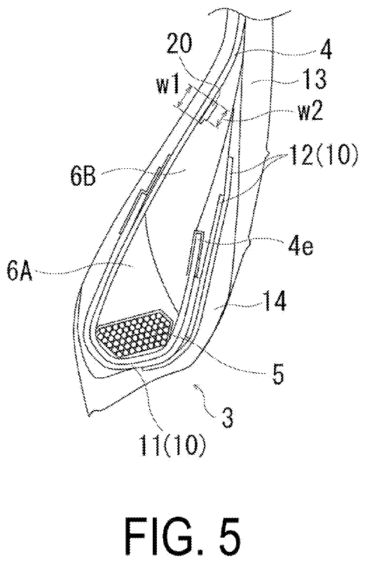

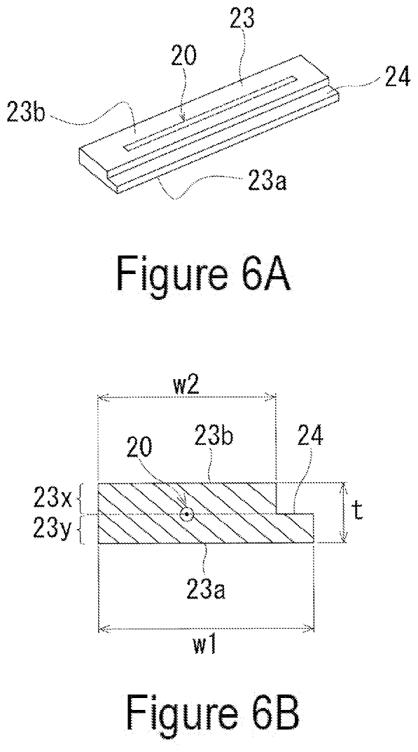

FIGS. 5 and 6A-6B illustrate another modified example of the pneumatic tire according to the embodiment of the present technology. As illustrated in FIGS. 5 and 6A-6B, the entirety of the transponder 20 is covered with a coating layer 23 made of rubber. The coating layer 23 has a surface 23a in contact with the carcass layer 4 and a surface 23b in contact with the bead filler 6, and widths w1 and w2 of the surfaces 23a and 23b are different from each other. Therefore, a step 24 (unevenness) is formed in the coating layer 23 so as to extend in the longitudinal direction thereof. The transponder 20 covered with the coating layer 23 includes an IC substrate and antennas protruding from both end portions of the IC substrate and having a helical shape.

In such a coating layer 23, an absolute value |w1-w2| of the difference between the width w1 on the side in contact with the carcass layer 4 and the width w2 on the side in contact with the bead filler 6 is preferably set to 0.2 mm or more. By appropriately setting the absolute value of the difference |w1-w2| as described above, the amount of unevenness around the transponder 20 can be reduced, and cracking resistance can be effectively improved. Furthermore, this enables the shape of the coating layer 23 to be stabilized, thus effectively improving the communication performance of the transponder 20.

FIGS. 5 and 6A-6B illustrate an example in which the width w1 on the side in contact with the carcass layer 4 is wider than the width w2 on the side in contact with the bead filler 6. However, the width w2 may be wider than the width w1. In addition, the step 24 is formed only on one side of the coating layer 23 in the width direction. However, the step 24 may be formed on both sides of the coating layer 23 in the width direction. Furthermore, if necessary, the step 24 can also be provided at the end portions of the coating layer 23 in the length direction.

In addition, the coating layer 23 includes a layer 23x and a layer 23y in the thickness direction of the coating layer 23. The layer 23x and the layer 23y are separated from each other in the thickness direction of the coating layer 23 with the center line of the transponder 20 as a boundary. For example, when forming the coating layer 23 having the cross-sectional shape illustrated in FIGS. 6A and 6B, the two layer 23x and layer 23y having different widths and a rectangular cross-sectional shape are used and layered such that end portions in the width direction on one side of the layer 23x and layer 23y coincide with each other to cover the entire transponder 20. This can form the step 24 at an end portion in the width direction on the other side of the layered coating layers 23.

Alternatively, a single coating layer 23 having a rectangular cross-sectional shape may be used, and the coating layer 23 may be folded to cover the entirety of the transponder 20. As another method, the step 24 may be formed by using two coating layers 23 having the same width and a rectangular cross-sectional shape, layering the coating layers 23 to cover the entirety of the transponder 20, and then removing an end portion at least on one side in the width direction of the layered coating layers 23.

### Examples

Pneumatic tires according to a Conventional Example and Examples 1 to 11 were manufactured. These pneumatic tires had a tire size of 275/80R22.5 and included a tread portion extending in the tire circumferential direction and having an annular shape, a pair of sidewall portions respectively disposed on both sides of the tread portion, and a pair of bead portions respectively disposed on inner sides of the sidewall portions in a tire radial direction. A bead filler was disposed on an outer periphery of a bead core of each of the bead portions, a carcass layer was mounted between the pair of bead portions, and the carcass layer was turned up around the bead core from a tire inner side to a tire outer side. In the pneumatic tires, a transponder (RFID tag) was embedded between the bead filler and the carcass layer, and a distance W, a ratio W/t, the arrangement between the carcass layer and the second bead filler, the hardness of the second bead filler, the material of carcass cords, the presence of a metal reinforcing layer, the arrangement above an upper end of the metal reinforcing layer, the arrangement above a carcass turned-up end, and the absolute value of the difference |w1-w2| were set as shown in Tables 1 and 2. In the Conventional Example and Examples 1 to 11, the hardness (JIS hardness) of the first bead filler was set to 70.

These test tires were evaluated for the communication performance of the tag and the cracking resistance by the following test methods. The results are shown in Tables 1 and 2.

### Communication Performance of Tag:

For each test tire, a communication operation with the tag was performed using a reader/writer. Specifically, the maximum communication distance was measured with the reader/writer at a power output of 250 mW and a carrier frequency of from 860 MHz to 960 MHz. Evaluation results are expressed as index values with the value of the Conventional Example being defined as 100. Larger index values indicate superior communication performance of the tag.

### Cracking Resistance:

Each test tire was mounted on a wheel having a standard rim, the air pressure was adjusted to 70% of the standard maximum air pressure, the load was set to the standard maximum load, and a running test was performed using a drum testing machine at a travel speed of 48 km/h and with a distance traveled of 10000 km. Thereafter, the depth of the crack in the sidewall portion at the embedded position of the tag was measured. Evaluation results are expressed as index values, using the reciprocals of the measurement values, with the value of the Conventional Example being defined as 100. Larger index values indicate superior cracking resistance of the tire.

TABLE 1

| | Conventional | Example | Example | Example | Example | Example |
|---|---|---|---|---|---|---|
| | Example | 1 | 2 | 3 | 4 | 5 |
| Distance W (mm) | 25 | 2 | 2 | 5 | 20 | 5 |
| Ratio W/t | 12.5 | 0.5 | 1.0 | 2.5 | 10.0 | 2.5 |
| Arrangement between carcass layer | N/A | N/A | N/A | N/A | N/A | Yes |
| and second bead filler | | | | | | |
| Hardness of second bead filler | 70 | 70 | 70 | 70 | 70 | 70 |
| Material of carcass cord | Organic | Organic | Organic | Organic | Organic | Organic |
| | fiber | fiber | fiber | fiber | fiber | fiber |
| Presence of metal reinforcing layer | N/A | N/A | N/A | N/A | N/A | N/A |
| Arrangement above upper end of | N/A | N/A | N/A | N/A | N/A | N/A |
| metal reinforcing layer | | | | | | |
| Arrangement above carcass turned- | N/A | N/A | N/A | N/A | N/A | N/A |
| up end | | | | | | |
| Absolute value of difference | 0 | 0 | 0 | 0 | 0 | 0 |
| \| w1 − w2 \| (mm) | | | | | | |
| Communication performance of tag | 100 | 103 | 105 | 104 | 103 | 105 |
| Cracking resistance | 100 | 101 | 103 | 104 | 105 | 106 |

TABLE 2

| | Example | Example | Example | Example | Example | Example |
|---|---|---|---|---|---|---|
| | 6 | 7 | 8 | 9 | 10 | 11 |
| Distance W (mm) | 5 | 5 | 5 | 5 | 5 | 5 |
| Ratio W/t | 2.5 | 2.5 | 2.5 | 2.5 | 2.5 | 2.5 |
| Arrangement between carcass layer | Yes | Yes | Yes | Yes | Yes | Yes |
| and second bead filler | | | | | | |
| Hardness of second bead filler | 60 | 60 | 60 | 60 | 60 | 60 |
| Material of carcass cord | Organic | Metal | Metal | Metal | Metal | Metal |
| | fiber | | | | | |
| Presence of metal reinforcing layer | N/A | N/A | Yes | Yes | Yes | Yes |
| Arrangement above upper end of | N/A | N/A | N/A | Yes | Yes | Yes |
| metal reinforcing layer | | | | | | |
| Arrangement above carcass turned- | N/A | N/A | N/A | N/A | Yes | Yes |
| up end | | | | | | |
| Absolute value of difference | 0 | 0 | 0 | 0 | 0 | 0.2 |
| \| w1 − w2 \| (mm) | | | | | | |
| Communication performance of tag | 105 | 105 | 105 | 106 | 107 | 108 |
| Cracking resistance | 107 | 108 | 109 | 110 | 111 | 112 |

As can be seen from Tables 1 and 2, in the pneumatic tires of Examples 1 to 11, compared with the Conventional Example, both the cracking resistance of the tire and the communication performance of the tag were improved.

The present disclosure includes the following Technologies [1] to [9].

Technology [1] is a pneumatic tire including: a tread portion extending in a tire circumferential direction and having an annular shape; a pair of sidewall portions respectively disposed on both sides of the tread portion; and a pair of bead portions respectively disposed on inner sides of the sidewall portions in a tire radial direction, a bead filler being disposed on an outer periphery of a bead core of each bead portion, a carcass layer being mounted between the pair of bead portions, and the carcass layer being turned up around the bead core from a tire inner side to a tire outer side, a transponder being embedded between the bead filler and the carcass layer, and a distance W from an outer surface of the transponder to an outer surface of the bead filler measured in a normal line direction of the carcass layer ranging from 2 mm to 20 mm.

Technology [2] is the pneumatic tire according to Technology [1], in which a maximum thickness t (mm) of the transponder and the distance W satisfy a relationship of 1≤W/t≤10.

Technology [3] is the pneumatic tire according to Technology [1] or [2], in which the bead filler includes a first bead filler disposed adjacent to a tire-radial-direction outer side of the bead core and a second bead filler disposed adjacent to a tire-radial-direction outer side of the first bead filler, and the transponder is disposed between the second bead filler and the carcass layer.

Technology [4] is the pneumatic tire according to Technology [3], in which a hardness of the second bead filler is lower than a hardness of the first bead filler and ranges from 55 to 65.

Technology [5] is the pneumatic tire according to any one of Technologies [1] to [4], in which a carcass cord constituting the carcass layer is a metal cord.

Technology [6] is the pneumatic tire according to any one of Technologies [1] to [5], in which a metal reinforcing layer is disposed on an outer side of the carcass layer in the bead portion.

Technology [7] is the pneumatic tire according to Technology [6], in which the metal reinforcing layer is turned up around the bead core from a tire inner side to a tire outer side, and the transponder is disposed on a tire-radial-direction outer side of a turned-up end portion of the metal reinforcing layer.

Technology [8] is the pneumatic tire according to any one of Technologies [1] to [7], in which the transponder is disposed on a tire-radial-direction outer side of a turned-up end portion of the carcass layer.

Technology [9] is the pneumatic tire according to any one of Technologies [1] to [8], in which the transponder is entirely covered with a coating layer made of rubber, and an absolute value |w1-w2| of a difference between a width w1 on a side of the coating layer in contact with the carcass layer and a width w2 on a side of the coating layer in contact with the bead filler is 0.2 mm or more.

1. A pneumatic tire comprising:
a tread portion extending in a tire circumferential direction and having an annular shape;
a pair of sidewall portions respectively disposed on both sides of the tread portion; and,
a pair of bead portions respectively disposed on inner sides of the sidewall portions in a tire radial direction,
a bead filler being disposed on an outer periphery of a bead core of each bead portion,
a carcass layer being mounted between the pair of bead portions, and,
the carcass layer being turned up around the bead core from a tire inner side to a tire outer side,
a transponder being embedded between the bead filler and the carcass layer, and,
a distance W from an outer surface of the transponder to an outer surface of the bead filler measured in a normal line direction of the carcass layer ranging from 2 mm to 20 mm.

2. The pneumatic tire according to claim 1, wherein a maximum thickness t (mm) of the transponder and the distance W satisfy a relationship of 1≤W/t≤10.

3. The pneumatic tire according to claim 1, wherein the bead filler comprises a first bead filler disposed adjacent to a tire-radial-direction outer side of the bead core and a second bead filler disposed adjacent to a tire-radial-direction outer side of the first bead filler, and the transponder is disposed between the second bead filler and the carcass layer.

4. The pneumatic tire according to claim 3, wherein a hardness of the second bead filler is lower than a hardness of the first bead filler and ranges from 55 to 65.

5. The pneumatic tire according to claim 1, wherein a carcass cord constituting the carcass layer is a metal cord.

6. The pneumatic tire according to claim 1, wherein a metal reinforcing layer is disposed on an outer side of the carcass layer in the bead portion.

7. The pneumatic tire according to claim 6, wherein the metal reinforcing layer is turned up around the bead core from a tire inner side to a tire outer side, and the transponder is disposed on a tire-radial-direction outer side of a turned-up end portion of the metal reinforcing layer.

8. The pneumatic tire according to claim 1, wherein the transponder is disposed on a tire-radial-direction outer side of a turned-up end portion of the carcass layer.

9. The pneumatic tire according to claim 1, wherein the transponder is entirely covered with a coating layer made of rubber, and an absolute value |w1-w2| of a difference between a width w1 on a side of the coating layer in contact with the carcass layer and a width w2 on a side of the coating layer in contact with the bead filler is 0.2 mm or more.

10. The pneumatic tire according to claim 2, wherein the bead filler comprises a first bead filler disposed adjacent to a tire-radial-direction outer side of the bead core and a second bead filler disposed adjacent to a tire-radial-direction outer side of the first bead filler, and the transponder is disposed between the second bead filler and the carcass layer.

11. The pneumatic tire according to claim 10, wherein a hardness of the second bead filler is lower than a hardness of the first bead filler and ranges from 55 to 65.

12. The pneumatic tire according to claim 11, wherein a carcass cord constituting the carcass layer is a metal cord.

13. The pneumatic tire according to claim 12, wherein a metal reinforcing layer is disposed on an outer side of the carcass layer in the bead portion.

14. The pneumatic tire according to claim 13, wherein the metal reinforcing layer is turned up around the bead core from a tire inner side to a tire outer side, and the transponder is disposed on a tire-radial-direction outer side of a turned-up end portion of the metal reinforcing layer.

15. The pneumatic tire according to claim 14, wherein the transponder is disposed on a tire-radial-direction outer side of a turned-up end portion of the carcass layer.

16. The pneumatic tire according to claim 15, wherein the transponder is entirely covered with a coating layer made of rubber, and an absolute value |w1-w2| of a difference between a width w1 on a side of the coating layer in contact with the carcass layer and a width w2 on a side of the coating layer in contact with the bead filler is 0.2 mm or more.
